(19) United States
(12) Patent Application Publication
(10) Pub. No.: US 2025/0388134 A1
(43) Pub. Date: Dec. 25, 2025

(54) VEHICLE SEAT

(71) Applicant: FAURECIA Sièges d'Automobile, NANTERRE (FR)

(72) Inventor: David EPAUD, LARDY (FR)

(21) Appl. No.: 19/242,078

(22) Filed: Jun. 18, 2025

(30) Foreign Application Priority Data
Jun. 21, 2024 (FR) 2406725

(51) Int. Cl. B60N 2/10; B60N 2/16; B60N 2/18; B60N 2/68

(52) U.S. Cl. CPC B60N 2/10; B60N 2/1615; B60N 2/1814; B60N 2/1853; B60N 2/682

(57) ABSTRACT

A vehicle seat includes: a structure mounted on the vehicle, a squab inclinable by an inclination α4, a backrest linked to the squab by a pivot link about a first axis, inclinable by a backrest inclination α5, a front connecting rod linked to the structure by a pivot link and linked to a front part of the squab by a pivot link, a rear connecting rod linked to the structure by a pivot link and linked to either the backrest or the squab by a pivot link of a second axle, and a first linear actuator linked to the backrest by a pivot link along a third axis distinct from the first axis and linked to the squab by a pivot link, where actuation of the first linear actuator providing simultaneous adjustment of squab inclination α4 and backrest inclination α5.

### PRIORITY CLAIM

This application claims priority to French Patent Application No. FR2406725, filed Jun. 21, 2024, which is expressly incorporated by reference herein.

### BACKGROUND

The field of the present disclosure is that of vehicle seats, in particular for motor vehicles. More specifically, the present disclosure relates to a vehicle seat. The present disclosure also relates to a vehicle comprising such a seat.

### SUMMARY

According to the present disclosure, a vehicle seats comprises:
A seat anchoring structure configured to be mounted on the vehicle,
a squab frame, inclinable with respect to a longitudinal axis by an inclination α4,
a backrest frame, linked to the squab frame by a first pivot link about a first axis, inclinable relative to a vertical axis by a backrest inclination α,
a front connecting rod linked to the anchoring structure by a second pivot link and linked to a front part of the squab frame by a third pivot link,
a rear connecting rod linked to the anchoring structure by a fourth pivot link, and linked to either the backrest frame or the squab frame by a fifth pivot link about a second axis,
a first linear actuator linked to the backrest frame by a sixth pivot link along a third axis distinct from the first axis and linked to the squab frame by a seventh pivot link,
configured so that actuation of the first linear actuator provides simultaneous adjustment of squab inclination α4 and backrest inclination α5.

Among other advantages, the solution of the present disclosure has the advantage of being greatly simplified compared with comparative mechanisms. A single linear actuator simultaneously adjusts the inclination of the backrest and squab, eliminating the need for complex backrest/seat articulation.

The features disclosed in the following paragraphs can optionally be implemented independently of one another or in combination with one another:

According to one improvement, the actuation of the first linear actuator, according to at least a first mode of adjustment of seat inclination, simultaneously allows the rotation of the front connecting rod with respect to the anchoring structure, the rotation of the squab frame with respect to the front connecting rod, the rotation of the backrest frame with respect to the squab frame and the rotation of the backrest frame with respect to the rear connecting rod, while the rear connecting rod is static with respect to the anchoring structure.

According to one improvement, the seat comprises a second linear actuator linked to the anchoring structure by an eighth pivot link and linked to the rear connecting rod by a ninth pivot link.

According to one improvement, the actuation of the second linear actuator, at least according to a second mode of adjustment of seat height, provides an adjustment of the height of the squab frame and of the backrest frame, by simultaneously allowing rotation of the front connecting rod relative to the anchoring structure and rotation of the rear connecting rod relative to the anchoring structure, as well as rotation of the squab frame relative to the front connecting rod and rotation of the squab frame relative to the rear connecting rod, while the backrest is static relative to the squab frame.

According to one improvement, the seat comprises a second linear actuator linked to the anchoring structure by an eighth pivot link and linked to the rear connecting rod by a ninth pivot link, configured to, at least in a combined mode of adjustment of the seat's inclination and elevation, simultaneously actuate the first linear actuator and the second linear actuator so as to simultaneously authorize rotation of the front connecting rod relative to the anchoring structure, rotation of the squab frame relative to the front connecting rod, rotation of the backrest frame relative to the squab frame and rotation of the backrest frame relative to the rear connecting rod, while the rear connecting rod is movable relative to the anchoring structure about the fourth pivot link, so as to simultaneously provide adjustment of the seat height and simultaneous adjustment of squab inclination α4 and backrest inclination α5.

According to one improvement, the rear connecting rod comprises a first end connected to either the backrest frame or the squab frame and a second end connected to the second linear actuator, the fourth pivot link connecting the rear connecting rod to the anchoring structure being located in a zone distinct from the first end or from the second end.

According to one improvement, the first linear actuator, and/or the second linear actuator if applicable, are irreversible actuators, configured to respectively block the rotation of the backrest frame with respect to the squab frame, and the rotation of the rear connecting rod with respect to the anchoring structure when they are not actuated.

According to an improvement, the first linear actuator, and the second linear actuator if applicable, each comprise a motor, a screw and a nut able to translate along the screw by the action of the motor.

In one embodiment, the second axis coincides with either the first or third axes.

According to one improvement, the third axis is located at a height relative to the anchoring structure which is less than the height of the first axis relative to the anchoring structure.

According to one improvement, actuation of the first linear actuator enables, for a 1° variation in squab inclination α4 with respect to the longitudinal axis, a variation in backrest inclination α5 with respect to the vertical axis of between 2.5° and 4°.

According to one improvement, the second linear actuator is connected to the anchoring structure in a first zone located in front, with respect to the longitudinal axis X, of a second zone in which the second linear actuator is connected to the rear connecting rod.

According to one improvement, the seat comprises a user interface configured to selectively:
trigger the at least one first mode for adjusting seat inclination, by activating the first actuator selectively to extend or retract, while the second linear actuator is not activated, and/or
trigger the at least one second mode for adjusting seat height, by activating the second actuator to extend or retract, while the first linear actuator is not activated, and/or
trigger the at least one third mode for combined adjusting of seat inclination and height.

The present disclosure further relates to a vehicle comprising a seat as previously described.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 shows a comparative kinematic diagram of a seat adjustment mechanism.

FIG. 2 shows a three-dimensional perspective view of a seat according to an example of the present disclosure.

FIG. 3 shows a kinematic diagram of a seat according to an example of the present disclosure.

FIG. 4 shows a kinematic diagram of a seat according to a second example of the present disclosure.

FIG. 5 shows a kinematic diagram of a seat according to a third example of the present disclosure.

FIG. 6 shows a kinematic diagram of a seat according to a fourth example of the present disclosure.

FIG. 7 shows a side view of a seat according to an example of the present disclosure, in the so-called “nominal” position.

FIG. 8 shows a side view of a seat according to an example of the present disclosure, in the so-called “relaxed” position.

FIG. 9 shows a side view of a seat according to an example of the present disclosure, in the so-called “lowered” position.

FIG. 10 shows a cross-section along a plane XZ at a first transverse value along the Y axis of a seat according to an example of the present disclosure, in the so-called “nominal” position.

FIG. 11 shows a cross-section along a plane XZ at a first transverse value along the Y axis of a seat according to an example of the present disclosure, in the so-called “relaxed” position.

FIG. 12 shows a cross-section along a plane XZ at a second transverse value along the Y axis of a seat according to an example of the present disclosure, in the so-called “nominal” position.

FIG. 13 shows a cross-section along a plane XZ at a second transverse value along the Y axis of a seat according to an example of the present disclosure, in the so-called “lowered” position.

### DETAILED DESCRIPTION

The following drawings and description contain, for the most part, elements of certainty. They may therefore not only serve to enhance understanding of this disclosure, but also contribute to its definition, where appropriate.

In the various figures, the same references designate identical or similar elements. For simplicity's sake, only the elements that are useful for understanding the described embodiment are shown in the figures and are described in detail below.

In the following description, when referring to terms qualifying absolute position, such as the terms “front”, “rear”, “top”, “bottom”, “left”, “right”, etc., or relative ones, such as the terms “above”, “below”, “upper”, “lower”, etc., or to qualifiers of orientation, such as “horizontal”, “vertical”, etc., reference is made, unless otherwise specified, to the orientation off a vehicle seat in its normal position of use, facing forward, so that an occupant of the seat is oriented in the direction in which the vehicle advances.

A direct X, Y, Z coordinate system is also provided, with the X axis running from rear to front, in a horizontal direction, which may correspond to the vehicle's direction of travel. The Z axis extends upwards in a vertical direction, and the Y axis extends in a transverse direction, in the conventional sense of a direct reference frame.

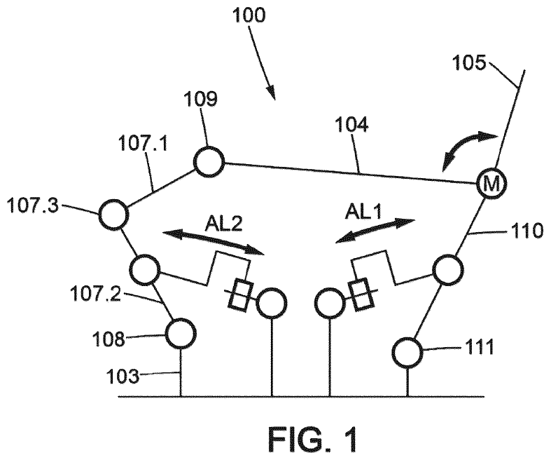

Reference is now made to FIG. 1, which shows a comparative adjustment mechanism. According to the example shown, such a mechanism comprises a squab frame 104, and a backrest frame 105, each of which is movable relative to a fixed anchoring structure 103, or more commonly movable in translation via a sliding system relative to a floor of the vehicle. The backrest frame 105 may be rotatably mounted on the squab frame 104 by means of a first manual or motorized joint M, which only adjusts the inclination of the backrest 105 relative to the squab 104, without affecting the position or inclination of the squab 104. Such an adjustment is represented by a double arched arrow on the figure. The squab frame 104 can be rotationally linked to a front connecting rod system 107.1, 107.2, 107.3, and to a rear connecting rod 110, each of the connecting rods also being rotationally linked with the anchoring structure 103. The mechanism comprises a first linear actuator AL1 linked in rotation with the anchoring structure 103 and the rear connecting rod 110, whose actuation, which results in a decrease or increase in the length marked by the double straight arrow, enables seat raising adjustment. The mechanism is also equipped with a second linear actuator AL2, linked in rotation with the anchoring structure 103 and with the front connecting rod 107.2, which is actuated to adjust the squab inclination. In other words, the angle between the backrest and squab remains constant even when the whole unit is tilted forwards or backwards.

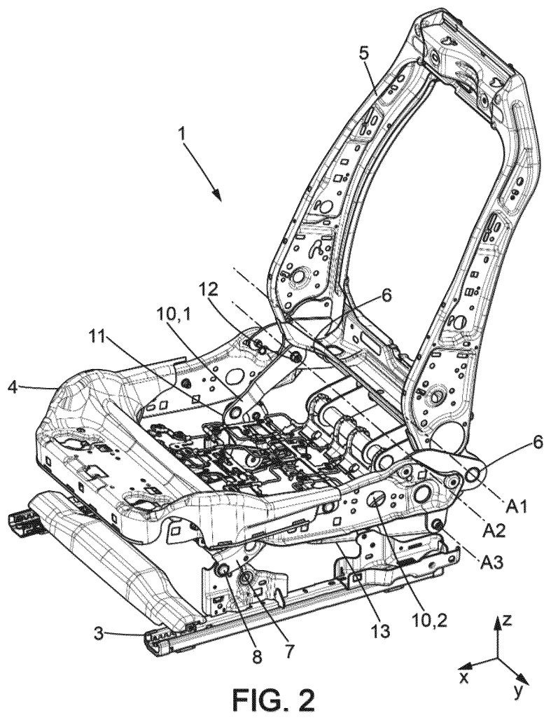

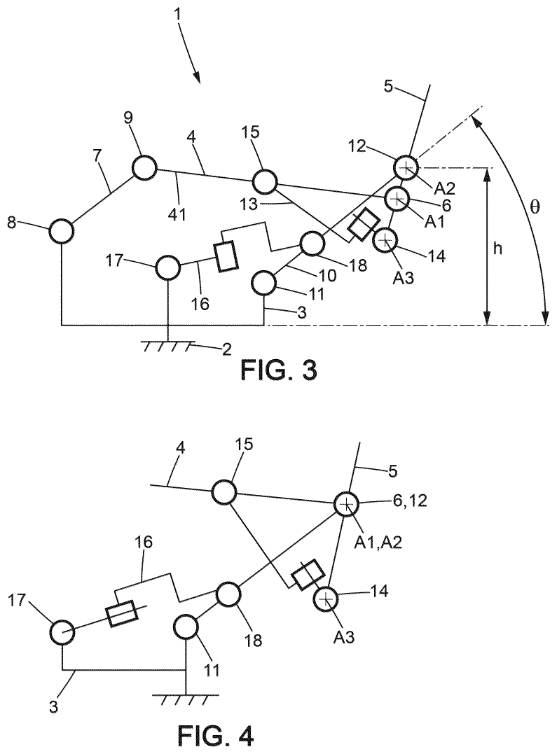

An example of a mechanism proposed in accordance with the present disclosure is shown in FIG. 2, in a three-dimensional perspective view. A so-called “kinematic” diagram of an example seat proposed according to the present disclosure is shown in FIG. 3. Both figures show a squab 4 frame and a backrest 5 frame, which can be moved relative to an anchoring structure 3. When the anchoring structure 3 comprises a fixed part and a movable part, for example a slide, the term “anchoring frame” is understood to refer to the movable part of the structure in relation to the vehicle floor.

The backrest 5 frame is linked to the squab 4 frame by a first pivot link 6, enabling these elements to rotate relative to each other about a first axis A1. Unlike comparative mechanisms, this pivot link allows free rotation, that is it is neither motorized nor manually operable. For example, this may be a bearing comprising two complementary cylindrical shapes, with or without bearings.

The seat 1 further comprises a front connecting rod 7 connected at a first end to the anchoring structure 3 by a second pivot link 8, and connected at a second end to a front part 41 of the squab 4 frame by a third pivot link 9. The front part 41 can be defined as the part of the squab frame, when substantially horizontal, extending forward from the middle of the distance between its two longitudinal ends (along the X axis). In other words, the front part 41 can be the front half of the squab 4 frame. It may also be an area near the front end of the squab 4 frame, or the front quarter of the squab 4 frame.

The mechanism is also equipped with a rear connecting rod 10 linked to the anchoring structure 3 by a fourth pivot link 11, and linked to either the backrest 5 frame or the squab 4 frame by a fifth pivot link 12 about a second axis A2. This second axis A2 can be substantially parallel to the first axis A1.

In some examples, this second axis A2 may be coincident with the first axis A1. Indeed, it may be advantageous for the first and fifth pivot links 6, 12 to share the same axis A1, A2. It is in this single configuration that the connecting rod can be linked to both the backrest 5 frame and the squab 4 frame without interfering with the kinematics of the mechanism. In other words, the first and fifth pivot links 6, 12 can be coaxial. Such an arrangement, shown as an example in FIG. 4, may have the advantage of being less bulky and less complex to implement.

The rear connecting rod 10 can be linked to either the backrest 5 frame or the squab 4 frame, since one of its functions is to enable the height of the first pivot link 6 linking these two elements to be adjusted. In this way, this function can be performed independently of whether the connecting rod 10 is connected to either the backrest 5 or the squab 4. In the non-limiting examples shown in FIGS. 2, 3, 10, 11, 12 and 13, the rear connecting rod 10 is attached to the backrest 5 frame.

In addition, the seat according to the present disclosure comprises a first linear actuator 13 linked, at a first end 131, to the backrest 5 frame by a sixth pivot link 14 along a third axis A3. This third axis A3 may be distinct from the first axis A1. The first linear actuator 13 is also connected, at a second end 132, to the squab 4 frame by a seventh pivot link 15. This linear actuator 13 is configured so that its actuation varies the length separating its two ends 131, 132, attached respectively to the backrest by the sixth pivot link 14 and to the squab by the seventh pivot link 15. Thus, moving these two pivot links 14, 15 towards or away from each other allows relative rotation between the backrest and squab about the first pivot link 6. The part of the backrest 5 frame extending between the first pivot link 6 and the sixth pivot link 14 advantageously acts as a lever arm. According to examples, in order to obtain this lever arm mechanism, the third axis A3 can be located at a height with respect to a horizontal plane at the level of the anchoring structure 3 which is less than the height of the first axis A1. In other words, the third axis A3 can be located lower along the vertical axis Z than the first axis A1.

In some examples, the second axis A2 is coincident with the third axis A3. In other words, as shown in FIG. 6 by way of a non-limiting example, it is possible for the fifth pivot link 12 and the sixth pivot link 14 to be coaxial with the coincident axes A2 and A3. This configuration can also offer advantages in terms of space requirements and ease of use.

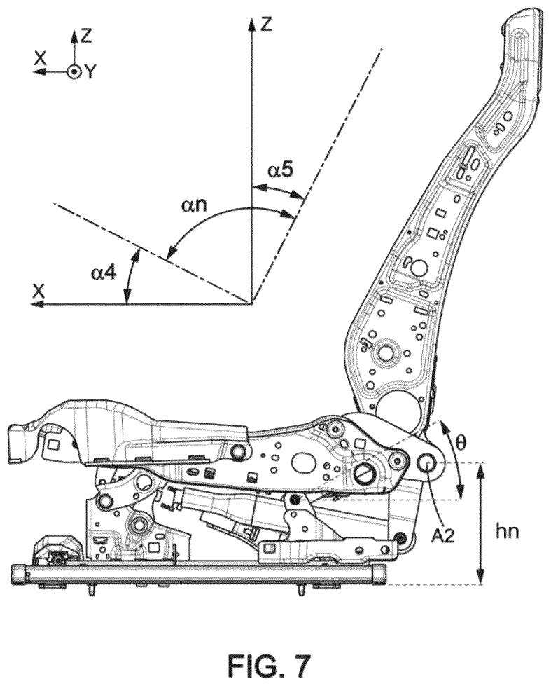

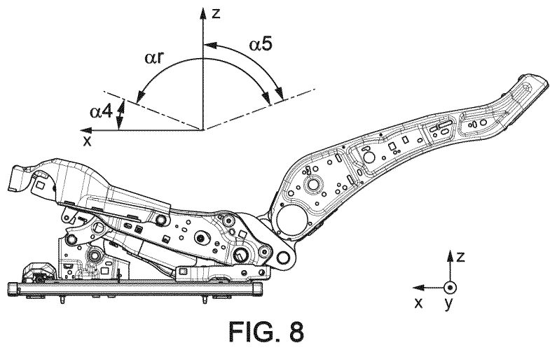

The controlled rotation described above caused by actuation of the first linear actuator 13 enables simultaneous adjustment of squab inclination α4 and backrest inclination α5, as shown by way of non-limiting examples in FIGS. 7 and 8. Indeed, the first linear actuator 13, according to at least a first mode of adjustment of seat inclination, simultaneously allows the rotation of the front connecting rod 7 with respect to the anchoring structure 3, the rotation of the squab 4 frame with respect to the front connecting rod 7, the rotation of the backrest 5 frame with respect to the squab 4 frame and the rotation of the backrest 5 frame with respect to the rear connecting rod 10, while the rear connecting rod 10 is static with respect to the anchoring structure 3.

In some examples, the rear connecting rod 10 can be held statically by locking the fourth pivot link 11, for example by a dog clutch mechanism, or by replacing the fourth pivot link 11 with an embedded link. In some examples, the rear connecting rod 10 can be kept static by adding a complementary rear connecting rod connecting a point on the rear connecting rod 10 to a point on the anchoring structure 3 distinct from the fourth pivot link 11, thus blocking, for example permanently, rotation relative to this fourth pivot link 11.

In other examples, the rear connecting rod 10 can be held statically relative to the anchoring structure, at least according to a first mode of seat inclination adjustment, by a second linear actuator 16 whose length can be controlled to remain constant during actuation of the first linear actuator 13, this second actuator 16 being linked at one end by an eighth pivot link 17, distinct from the fourth pivot link 11, to the anchoring structure 3, and at another end to the rear connecting rod 10 by a ninth pivot link 18.

The first and second linear actuators 13, 16 can be of any suitable type. According to the examples described in more detail below, they can comprise motors and screw-and-nut mechanisms, with or without ball bearings. They can also be cylinders whose length is varied by the action of a fluid. They can also be electric linear motors.

In examples where the seat is fitted with a second linear actuator 16, this can be used to adjust the height h of the squab 4 frame and backrest 5 frame. In fact, its actuation can simultaneously allow rotation of the front connecting rod 7 relative to the anchoring structure 3 and rotation of the rear connecting rod 10 relative to the anchoring structure 3, as well as rotation of the squab 4 frame relative to the front connecting rod 7 and of the squab 4 frame relative to the rear connecting rod 10, while the backrest 5 is static relative to the squab 4 frame. For example, the backrest 5 can be held statically relative to the squab 4 frame by the first linear actuator 13. The first linear actuator 13 can be controlled to keep its length constant, thus blocking rotation of the backrest relative to the squab 4 around the first pivot link 6.

According to one embodiment, the seat can thus comprise a user interface configured to selectively:
trigger the at least one first mode for adjusting seat inclination, by activating the first actuator selectively to extend or retract, while the second linear actuator 16 is not activated, and/or
trigger the at least one second mode for adjusting seat height, by activating the second actuator to extend or retract, while the first linear actuator 13 is not activated, and/or
trigger the at least one third mode for combined adjusting of seat 1 inclination and height.

The user interface may comprise electrical contacts, or a touch screen, the interface configured to control actuation of the actuator (first or second), selectively in an extending or retracting direction.

The first actuator can, for example, be operated selectively for extending or retracting, while the second actuator is operated selectively for extending or retracting (or vice versa).

In some examples, the second linear actuator 16 is connected to the anchoring structure 3 in a first zone 16.1 located in front, with respect to the longitudinal axis X, of a second zone 16.2 in which the second linear actuator 16 is connected to the rear connecting rod 10. In this way, the two motors of the two linear actuators 13, 16 can both be located at the front of the seat, facilitating motor assembly and electrical wiring, as well as maintenance operations: it is not necessary to provide access to two separate areas to operate on either of the two motors of the two linear actuators 13, 16.

As shown in the non-limiting examples in FIGS. 7 and 8, actuation of the first linear actuator 13 enables simultaneous adjustment of squab inclination α4 and backrest inclination α5, to influence the total angle α between a seat plane and a backrest plane. A particular seat configuration called the “nominal position” is reached for an angle α=αn. Such a configuration is shown in FIG. 7. FIG. 8 shows a second particular configuration, which corresponds to an extreme stroke of the first linear actuator 13, and results in a so-called “relaxed” or “extended” position which has an angle α=αr. The occupant is then moved to a lying position. According to the present disclosure, such a “relaxed” position can be reached by actuating only the first linear actuator 13, while the second linear actuator 16 can remain at rest, in a state wherein its length remains constant.

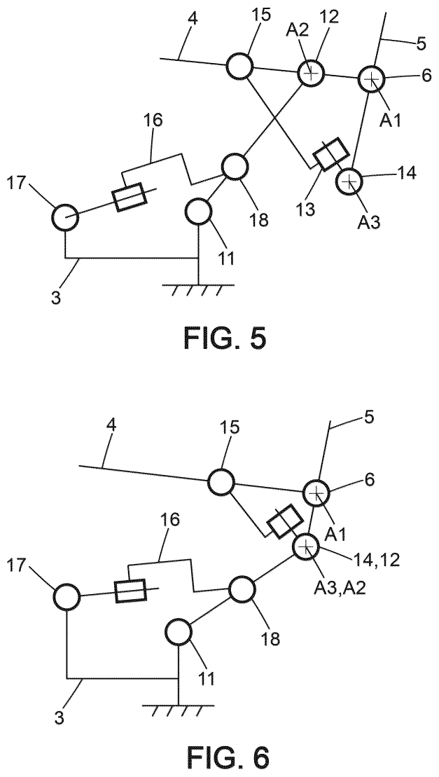

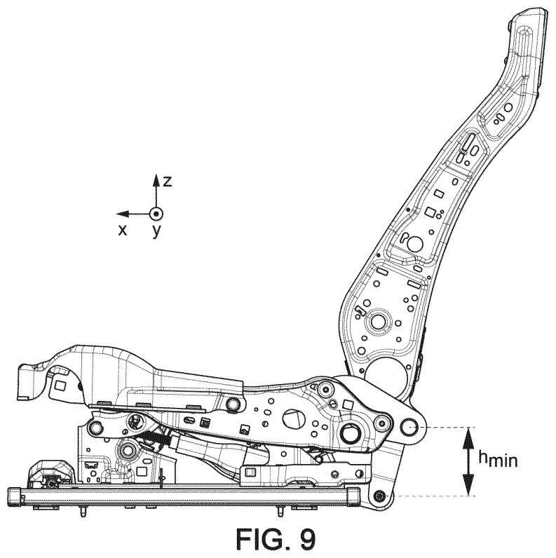

According to the non-limiting examples shown in FIGS. 3 to 6 and FIG. 9, actuation of the second linear actuator 16 rotates the rear connecting rod 10 about the fourth pivot link 11 with the anchoring structure 3. This rotation of the rear connecting rod 10 involves an increase or decrease in the height h between a horizontal plane, parallel to the longitudinal axis X, located at the anchoring structure 3, and the axis A2 of the fifth pivot link 12 between the rear connecting rod 10 and one and/or other of the squab 4 or backrest 5. The second linear actuator 16 can thus be used to adjust the seat height. In particular, it can be seen by comparing the heights between axis A2 and a horizontal plane at anchoring structure 3 in FIGS. 7 and 9, that the height can vary. In this example, the height varies from a value hn to a value hmin.

It is also understood that, thanks to the front and rear connecting rod mechanism 7, 10, seat height adjustment is accompanied by a forward or backward movement. This movement occurs forwards when the seat height is increased, and backwards when the height is reduced.

In examples, it may be advantageous that, when the seat is in its nominal position with an angle α=αn, the rear connecting rod 10 forms an angle θ of less than 60°, preferentially between 3° and 60°, or even more preferentially between 1° and 30°, with a horizontal plane parallel to the X axis. This provides that a relatively small variation in the length of the second actuator 16 results in a relatively large variation in the height of the A2 axis. Potentially advantageously, the smaller the angle, the smaller the forward or backward movement that accompanies seat height adjustment.

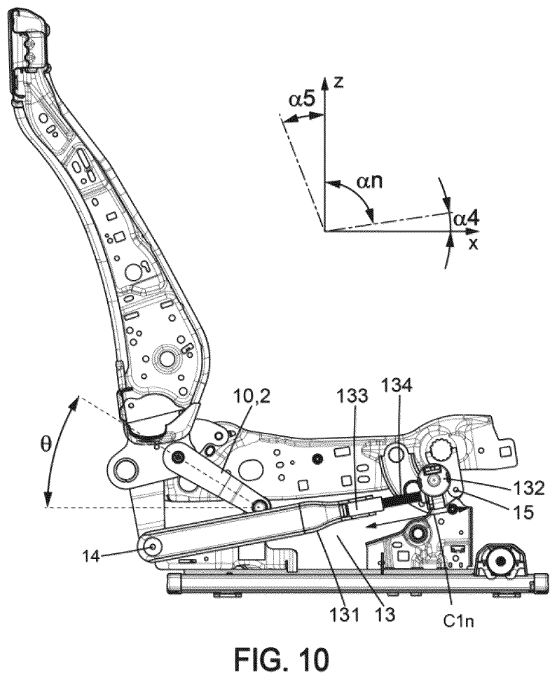

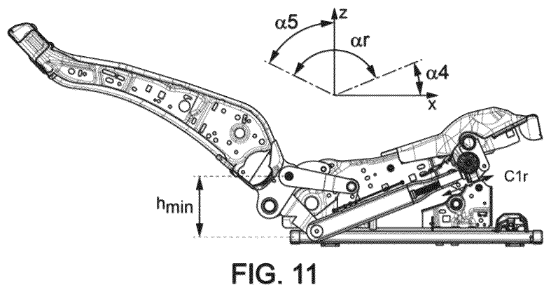

Reference is now made to FIGS. 10 and 11, which show in greater detail the inclination adjustment according to a non-limiting example. The first linear actuator 13 is particularly visible here. In this example, it comprises a screw-and-nut mechanism, coupled to an electric motor. In this example, it is the screw that is linked to the motor, but it is of course possible to provide a reverse configuration wherein it is the nut that is driven by the motor. Here it comprises a first movable end 131 fitted with a nut 133 and a second fixed end 132 fitted with a screw 134 which can be rotated by a motor. The nut 133 is configured to cooperate with the screw 134 which, when driven by the motor, enables the nut 133 to be driven in translation along the axis of the screw. The length between the sixth pivot link 14 and the seventh pivot link 15 can thus be varied, allowing the backrest 5 to tilt relative to the squab 4 around the first pivot link 6.

FIG. 10 shows a seat according to one example in a so-called “nominal” position, wherein the angle α=αn. In this particular configuration, nut 133 is located at the free end of screw 134, at a distance from the motor, the length between nut 133 and seventh pivot link 15 being equal to C1n. The length of the first linear actuator 13 is maximum in this example. FIG. 11 shows an example of a seat wherein the nut 133 abuts close to the motor, at the proximal end of screw 134. This corresponds to the minimum length C1r of the first linear actuator 16 in this example. This is the particular position referred to as “relaxed”, wherein the angle α=αr and the occupant is lying down.

In some examples, the length C1n of the first linear actuator 13 in nominal position is greater than the length C1r of the first linear actuator in “relaxed” position.

According to examples, actuation of the first linear actuator 13 can enable, for a 1° variation in squab inclination α4 relative to a horizontal axis X, a variation in backrest inclination α5 relative to a vertical axis Z of between 1° and 10°, preferentially between 2° and 6°, even more preferentially between 2.5° and 4°. In particular, it can be seen by comparing FIGS. 10 and 11, that the squab inclination value α4 varies less than the backrest inclination value α5 by actuation of the first linear actuator 13.

In other words, according to examples, a variation in the length of the first linear actuator 13 by a given unit of length varies the backrest inclination value α5 to a greater extent than the squab inclination value α4. For this reason, the total angle α between the backrest and squab varies simply by operating the first linear actuator 13.

The first and second linear actuators 13, 16 can be operated at the same time, as shown in FIGS. 10 and 11. This is the case at least for the third mode of combined adjusting of seat inclination and height. In this case, the height h of axis A2 varies with the angle α between backrest 5 and squab 4. Particularly for greater comfort in the “relaxed” position, it can be advantageous to set the seat height h=hmin to a minimum, while the inclinations of backrest 5 and squab 4 are set to a maximum.

It is possible that actuation of the first linear actuator 13 alone may cause the seat to reach the “relaxed” position wherein the angle α reaches the value of 120°, or more. It is also possible that simultaneous, partially simultaneous or successive actuation of the second linear actuator 16 brings the seat into a “low” raised position, wherein h=hmin. The value of hmin may, for example, be substantially equal to 100 mm.

In some examples, the user interface may comprise a command enabling the occupant to select the “relaxed” position, the interface then controlling at least the first linear actuator 13 so that the seat reaches the value α=120°, and optionally, also controlling the second linear actuator 16 so that the seat reaches the height h=hmin, hmin being substantially equal to 100 mm, for example.

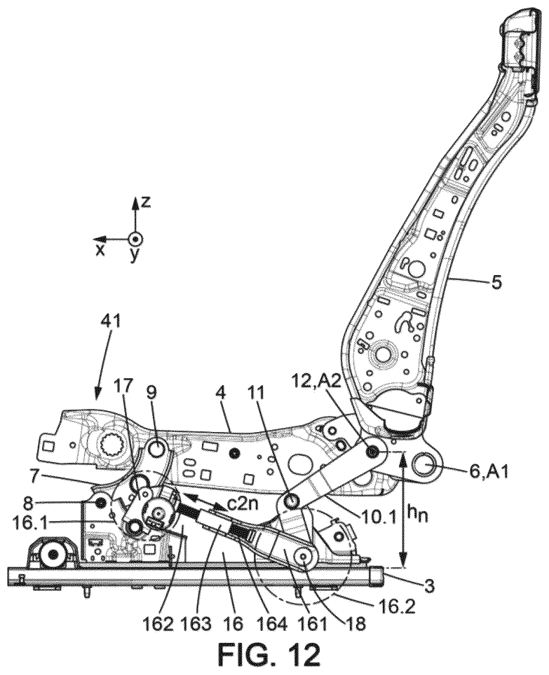

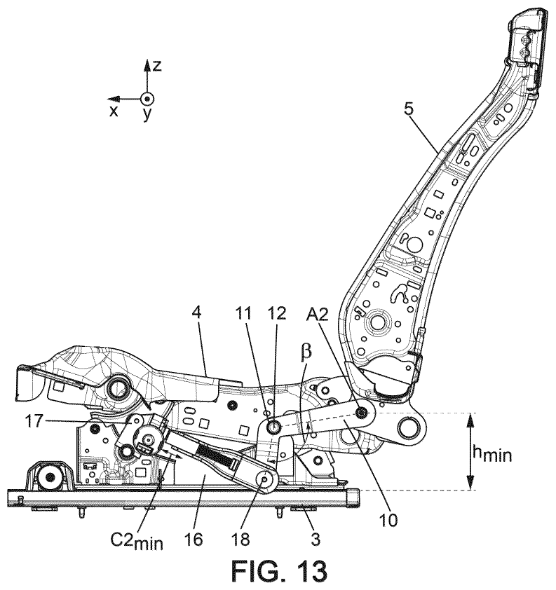

Reference is now made to FIGS. 12 and 13, which show a non-limiting example of how to adjust the height of seat 1. The second linear actuator 16 is particularly visible here. In this example, it comprises a screw-and-nut mechanism, coupled to an electric motor. The second linear actuator 16 is therefore similar in design to the first linear actuator 13, but in other examples, they may be of different design. The second linear actuator 16 here comprises a first movable end 161 fitted with a nut 163 and a second fixed end 162 fitted with a screw 164 which can be rotated by a motor. The nut 163 is configured to cooperate with the screw 164 which, when driven by the motor, enables the nut 163 to be driven in translation. Similarly, it is possible to provide a reverse configuration wherein it is the nut 163 that is driven by the motor. The length between the eighth pivot link 17 and the ninth pivot link 18 can thus be varied, allowing the rear connecting rod 10 to inclination relative to the anchoring structure 3 around the fourth pivot link 11, thereby lowering or raising the axis A2 of the fifth pivot link 12.

FIG. 12 shows an example of a seat in nominal position. The height h of axis A2 of pivot link 12 is equal to hn, which corresponds to the nominal height of the seat. In this case, nut 163 is located approximately in the middle of the length of screw 164. In fact, it may be advantageous to be able to lower or raise the seat 1 from its nominal position, in which case the nominal position may correspond to an intermediate position between the seat's minimum and maximum height (not shown). In this example, in the nominal position, the second linear actuator 16 is such that the length between the nut 163 and the eighth pivot link 17 is equal to C2n.

It is obvious that the particular nominal, low and “relaxed” positions are shown here as particular examples to illustrate the operation of a seat according to the present disclosure, but that the seat can be adjusted to a multitude of other positions as long as they are allowed by the maximum stroke of the linear actuators, as well as to all intermediate positions between these remarkable positions.

FIG. 13 shows an example of a seat in “lowered” position. The seat has been lowered from its nominal position so that the height h of axis A2 is now equal to hmin, which is less than hn. To this end, the second linear actuator 16 has been actuated so that the length between the nut 163 and the eighth pivot link 17 decreases, so as to reach the minimum value C2 min, which is less than C2n. Such height adjustment is performed by actuating a single actuator, the second linear actuator 16.

According to the present disclosure, the vehicle seat 1 may comprise several front connecting rods 7 and several rear connecting rods 10. In particular, it may be advantageous for the vehicle seat to have two front connecting rods 7 and two rear connecting rods 10, each located at the lateral sides of the seat so as to effectively balance and distribute the seat load. In other words, the front 7 and rear 10 connecting rods can each be located at different values on the transverse Y axis. In other examples, the seat may have more than two front and/or rear connecting rods, for example three, four or more.

Examples include a first rear connecting rod 10.1 and a second rear connecting rod 10.2. The second linear actuator 16 may be linked to just one of the two rear connecting rods 10. In one example, shown in FIGS. 12 and 13, the second linear actuator 16 is linked to the first rear connecting rod 10.1.

For example, the first connecting rod 10.1 may have a different shape to the second connecting rod 10.2. FIGS. 10 and 11 show a second connecting rod 10.2 which is not connected to the second linear actuator 16. It thus has a generally rectilinear shape, connecting the fourth and fifth pivot links 11 and 12.

According to examples, the first rear connecting rod 10.1 can extend so as to connect the ninth pivot link 18 of the second actuator at a first end to the fifth pivot link 12 at a second end, the fourth pivot link 11 then being located between the first and second ends of the first rear connecting rod 10.1. In this way, a force applied to the first end at link 18 by the second actuator 16 causes the first rear connecting rod 10.1 to tilt around link 11.

The first rear connecting rod 10.1 can have an angled shape, as shown in an example in FIGS. 12 and 13, or a generally rectilinear shape as shown schematically in FIGS. 3 to 6. Potentially advantageously, the first rear connecting rod 10.1 may have a bend at the fourth pivot link 11. Indeed, a first straight line passing, on the one hand, through the ninth pivot link 18 and the fourth pivot link 11, and a second straight line, on the other hand, passing through the fourth pivot link 11 and the fifth pivot link 12, can form between them a non-flat angle, that is different from 0° and 180°. For example, this angle β can be between 9° and 135°.

In examples, one or both of the first and second linear actuators 13, 16 may be irreversible. In other words, no load other than the controlled actuation of the actuator in question can vary its length. In other words, if the linear actuator in question has a driving element and a driven element, the driven element cannot, under any operating conditions, take on the role of the driving element. This is particularly useful in the event of sudden vehicle deceleration, such as in a crash or other emergency. It may be advantageous that a force exerted on the driven element, for example the folder 5 in the case of the first linear actuator 13, cannot act on the length of the first linear actuator 13.

If reversible, the linear actuators 13, 16 can each be configured to respectively block rotation of the backrest 5 frame relative to the squab 4 frame, and rotation of the rear connecting rod 10 relative to the anchoring structure 3 when not actuated. In one example, if the first and/or second linear actuators 13, 16 comprise screw 134, 164 and nut 133, 163 mechanisms, the helix angle of the screw and nut threads can be sized so that a load on the moving part 131, 161 of the actuator 13, 16 in question does not cause a variation in the length of the actuator 13, 16.

The present disclosure relates to a vehicle seat, irrespective of whether it is a driver's seat or a passenger's seat. It is possible, however, for the vehicle seat to be a passenger seat. The passenger occupant needs less freedom than the driver to adjust the seat's parameters (height, inclination). The solution of the present disclosure therefore finds an application that may prove particularly attractive for a passenger seat.

A vehicle seat for a passenger or driver may comprise an assembly comprising a squab part and a backrest part, the assembly being configured to accommodate a vehicle occupant. A mechanism may adjust the inclinations of these backrest and squab parts, in particular relative to horizontal and/or vertical planes of the vehicle, as well as to adjust the height of the assembly. These adjustments not only improve seat comfort, but also enhance occupant safety. Particularly for the driver's seat, such adjustments also improve the occupant's visibility and facilitate access to the various controls.

Comparative vehicle seats comprise a squab frame and a backrest frame, each of which is movable relative to a fixed anchoring structure or in translation via a sliding system relative to a vehicle floor. The backrest frame is typically rotatably mounted on the squab frame by means of a manual or motorized joint, which only adjusts the inclination of the backrest relative to the squab, without affecting the position or inclination of the squab. The squab frame can be rotationally linked to a front connecting rod and a rear connecting rod, each of the connecting rods also being rotationally linked to the anchoring structure. The mechanism generally comprises a first linear actuator rotationally linked with the anchoring structure and the rear connecting rod, the actuation of which enables the seat height to be adjusted. A second linear actuator may be used, which is rotationally linked with the anchoring structure and with the front connecting rod, which is operated to adjust the inclination of the seat.

Although this type of comparative mechanism is satisfactory in that it allows great freedom of adjustment, it has many components, notably a manually or motorized joint and two linear actuators, and remains complex to implement. In addition, it is necessary to reinforce and lock the joint between the backrest and squab in the event of sudden braking or a crash, to prevent the backrest from being rotated by the vehicle's deceleration. As a result, such a mechanism has a higher risk of failure and a greater mass, which can increase the energy consumption of the vehicles on which it is installed.

The purpose of the present disclosure is therefore to at least partially overcome the above-mentioned drawbacks of the comparative mechanisms.

In particular, one objective of the present disclosure is to propose a solution which is simpler and more reliable than these comparative mechanisms, and which is also lighter, while retaining satisfactory performance with regard to the comfort and safety of vehicle occupants.

The above-mentioned objectives are achieved in particular by vehicle seats comprising:
A seat anchoring structure configured to be mounted on the vehicle,
a squab frame, inclinable with respect to a longitudinal axis by an inclination α4,
a backrest frame, linked to the squab frame by a first pivot link about a first axis, inclinable relative to a vertical axis by a backrest inclination α5,
a front connecting rod linked to the anchoring structure by a second pivot link and linked to a front part of the squab frame by a third pivot link,
a rear connecting rod linked to the anchoring structure by a fourth pivot link, and linked to either the backrest frame or the squab frame by a fifth pivot link about a second axis,
a first linear actuator linked to the backrest frame by a sixth pivot link along a third axis distinct from the first axis and linked to the squab frame by a seventh pivot link, configured so that actuation of the first linear actuator provides simultaneous adjustment of squab inclination α4 and backrest inclination α5.

Among other advantages, the solution of the present disclosure has the advantage of being greatly simplified compared with comparative mechanisms. A single linear actuator simultaneously adjusts the inclination of the backrest and squab, eliminating the need for complex backrest/seat articulation.

The features disclosed in the following paragraphs can optionally be implemented independently of one another or in combination with one another:

According to one improvement, the actuation of the first linear actuator, according to at least a first mode of adjustment of seat inclination, simultaneously allows the rotation of the front connecting rod with respect to the anchoring structure, the rotation of the squab frame with respect to the front connecting rod, the rotation of the backrest frame with respect to the squab frame and the rotation of the backrest frame with respect to the rear connecting rod, while the rear connecting rod is static with respect to the anchoring structure.

According to one improvement, the seat comprises a second linear actuator linked to the anchoring structure by an eighth pivot link and linked to the rear connecting rod by a ninth pivot link.

According to one improvement, the actuation of the second linear actuator, at least according to a second mode of adjustment of seat height, provides an adjustment of the height of the squab frame and of the backrest frame, by simultaneously allowing rotation of the front connecting rod relative to the anchoring structure and rotation of the rear connecting rod relative to the anchoring structure, as well as rotation of the squab frame relative to the front connecting rod and rotation of the squab frame relative to the rear connecting rod, while the backrest is static relative to the squab frame.

According to one improvement, the seat comprises a second linear actuator linked to the anchoring structure by an eighth pivot link and linked to the rear connecting rod by a ninth pivot link, configured to, at least in a combined mode of adjustment of the seat's inclination and elevation, simultaneously actuate the first linear actuator and the second linear actuator so as to simultaneously authorize rotation of the front connecting rod relative to the anchoring structure, rotation of the squab frame relative to the front connecting rod, rotation of the backrest frame relative to the squab frame and rotation of the backrest frame relative to the rear connecting rod, while the rear connecting rod is movable relative to the anchoring structure about the fourth pivot link, so as to simultaneously provide adjustment of the seat height and simultaneous adjustment of squab inclination α4 and backrest inclination α5.

According to one improvement, the rear connecting rod comprises a first end connected to either the backrest frame or the squab frame and a second end connected to the second linear actuator, the fourth pivot link connecting the rear connecting rod to the anchoring structure being located in a zone distinct from the first end or from the second end.

According to one improvement, the first linear actuator, and/or the second linear actuator if applicable, are irreversible actuators, configured to respectively block the rotation of the backrest frame with respect to the squab frame, and the rotation of the rear connecting rod with respect to the anchoring structure when they are not actuated.

According to an improvement, the first linear actuator, and the second linear actuator if applicable, each comprise a motor, a screw and a nut able to translate along the screw by the action of the motor.

In one embodiment, the second axis coincides with either the first or third axes.

According to one improvement, the third axis is located at a height relative to the anchoring structure which is less than the height of the first axis relative to the anchoring structure.

According to one improvement, actuation of the first linear actuator enables, for a 1° variation in squab inclination α4 with respect to the longitudinal axis, a variation in backrest inclination α5 with respect to the vertical axis of between 2.5° and 4°.

According to one improvement, the second linear actuator is connected to the anchoring structure in a first zone located in front, with respect to the longitudinal axis X, of a second zone in which the second linear actuator is connected to the rear connecting rod.

According to one improvement, the seat comprises a user interface configured to selectively:
trigger the at least one first mode for adjusting seat inclination, by activating the first actuator selectively to extend or retract, while the second linear actuator is not activated, and/or
trigger the at least one second mode for adjusting seat height, by activating the second actuator to extend or retract, while the first linear actuator is not activated, and/or
trigger the at least one third mode for combined adjusting of seat inclination and height.

The present disclosure further relates to a vehicle comprising a seat as previously described.

A vehicle (2) seat (1) comprising:
A structure (3) mounted on the vehicle (2),
a squab (4), inclinable by an inclination α4,
a backrest (5), linked to the squab (4) by a pivot link (6) about a first axis (A1), inclinable by a backrest inclination α5,
a front connecting rod (7) linked to the structure (3) by a pivot link (8) and linked to a front part (41) of the squab (4) by a pivot link (9),
a rear connecting rod (10) linked to the structure (3) by a pivot link (11), and linked to either the backrest (5) or the squab (4) by a pivot link (12) of a second axle (A2),
a first linear actuator (13) linked to the backrest (5) by a pivot link (14) along a third axis (A3) distinct from the first axis (A1) and linked to the squab (4) by a pivot link (15),
actuation of the first linear actuator (13) providing simultaneous adjustment of squab inclination α4 and backrest inclination α5.

1. A vehicle seat comprising:
A seat anchoring structure configured to be mounted on the vehicle,
a squab frame, inclinable with respect to a longitudinal axis by an inclination α4,
a backrest frame, linked to the squab frame by a first pivot link about a first axis, inclinable relative to a vertical axis by a backrest inclination α5,
a front connecting rod linked to the anchoring structure by a second pivot link and linked to a front part of the squab frame by a third pivot link,
a rear connecting rod linked to the anchoring structure by a fourth pivot link, and linked to either the backrest frame or the squab frame by a fifth pivot link about a second axis,
a first linear actuator linked to the backrest frame by a sixth pivot link along a third axis distinct from the first axis and linked to the squab frame by a seventh pivot link,
configured so that actuation of the first linear actuator provides simultaneous adjustment of squab inclination α4 and backrest inclination α5.

2. The vehicle seat of claim 1, wherein, according to at least a first mode of adjustment of seat inclination, actuating the first linear actuator simultaneously allows the rotation of the front connecting rod relative to the anchoring structure, rotation of the squab frame relative to the front connecting rod, rotation of the backrest frame relative to the squab frame and rotation of the backrest frame relative to the rear connecting rod, while the rear connecting rod is static relative to the anchoring structure.

3. The vehicle seat of claim 1, comprising a second linear actuator connected to the anchoring structure by an eighth pivot link and connected to the rear connecting rod by a ninth pivot link.

4. The vehicle seat of claim 3, wherein at least according to a second mode of adjustment of seat height, actuation of the second linear actuator provides adjustment of the height of the squab frame and of the backrest frame, simultaneously allowing rotation of the front connecting rod relative to the anchoring structure and rotation of the rear connecting rod relative to the anchoring structure, as well as rotation of the squab frame relative to the front connecting rod and of the squab frame relative to the rear connecting rod, while the backrest is static relative to the squab frame.

5. The vehicle seat of claim 1, comprising a second linear actuator linked to the anchoring structure by an eighth pivot link and linked to the rear connecting rod by a ninth pivot link, configured to, at least in a combined mode of adjustment of the seat's inclination and elevation, simultaneously actuate the first linear actuator and the second linear actuator so as to simultaneously authorize rotation of the front connecting rod relative to the anchoring structure, rotation of the squab frame relative to the front connecting rod, rotation of the backrest frame relative to the squab frame, and rotation of the backrest frame relative to the rear connecting rod, while the rear connecting rod is movable relative to the anchoring structure about the fourth pivot link, so as to simultaneously provide adjustment of the seat height and simultaneous adjustment of squab inclination α4 and backrest inclination α5.

6. The vehicle seat of claim 3, wherein the rear connecting rod comprises a first end connected to either the backrest frame or the squab frame and a second end connected to the second linear actuator, the fourth pivot link connecting the rear connecting rod to the anchoring structure being located in an area distinct from the first end or the second end.

7. The vehicle seat of claim 3, wherein the first linear actuator, and/or the second linear actuator are irreversible actuators, configured to respectively block rotation of the backrest frame relative to the squab frame, and rotation of the rear connecting rod relative to the anchoring structure when not actuated.

8. The vehicle seat of claim 3, wherein the first linear actuator, and the second linear actuator each comprise a motor, a screw and a nut able to translate along the screw by the action of the motor.

9. The vehicle seat of claim 1, wherein the second axis is coincident with either the first axis or the third axis.

10. The vehicle seat of claim 1, wherein the third axis is located at a height relative to the anchoring structure which is less than the height of the first axis relative to the anchoring structure.

11. The vehicle seat of claim 1, wherein actuation of the first linear actuator enables, for a 1° variation in squab inclination α4 with respect to the longitudinal axis, a variation in backrest inclination α5 with respect to the vertical axis of between 2.5° and 4°.

12. The vehicle seat of claim 3, wherein the second linear actuator is connected to the anchoring structure at a first zone located in front, with respect to the longitudinal axis X, of a second zone at which the second linear actuator is connected to the rear connecting rod.

13. The vehicle seat of claim 1, comprising a user interface configured to selectively:
trigger the at least one first mode for adjusting seat inclination, by activating the first actuator selectively to extend or retract, while the second linear actuator (16) is not activated, and/or
trigger the at least one second mode for adjusting seat height, by activating the second actuator to extend or retract, while the first linear actuator is not activated, and/or
trigger the at least one third mode for combined adjusting of seat inclination and height.

14. A vehicle comprising the seat according to claim 1.
